(19) United States
(12) Patent Application Publication
(10) Pub. No.: US 2012/0144169 A1
(43) Pub. Date: Jun. 7, 2012

(54) INFORMATION PROCESSING APPARATUS, INFORMATION PROCESSING METHOD, AND COMPUTER READABLE MEDIUM

(75) Inventor: Youichi ISAKA, Kanagawa (JP)

(73) Assignee: FUJI XEROX CO., LTD., Tokyo (JP)

(21) Appl. No.: 13/227,240

(22) Filed: Sep. 7, 2011

(30) Foreign Application Priority Data
Dec. 3, 2010 (JP) 2010-270629

(51) Int. Cl. G06F 9/312

(52) U.S. Cl. 712/220; 712/E09.033

(57) ABSTRACT

An information processing apparatus includes the following elements. A generator generates, on the basis of instruction information which describes processing to be executed for obtaining output data from raw data, processing definition information that defines details of the processing, upon inputting the instruction information. A determination unit determines whether output data associated with the currently generated processing definition information and data to be used as raw data is stored in a first memory, the first memory storing therein output data which has been obtained in accordance with previously generated processing definition information in association with data used as the raw data and the processing definition information. An output unit outputs, if the determination unit determines that the output data is stored in the first memory, the output data stored in the first memory without causing a processor to execute the processing.

### CROSS-REFERENCE TO RELATED APPLICATIONS

This application is based on and claims priority under 35 USC 119 from Japanese Patent Application No. 2010-270629 filed Dec. 3, 2010.

### BACKGROUND

(i) Technical Field

The present invention relates to information processing apparatuses, information processing methods, and computer readable media.

### SUMMARY

According to an aspect of the invention, there is provided an information processing apparatus including the following elements. A generator generates, on the basis of instruction information which describes processing to be executed for obtaining output data from raw data, processing definition information that defines details of the processing, upon inputting the instruction information from a processing request source. A determination unit makes a determination regarding whether output data associated with the processing definition information generated by the generator and associated with data to be used as raw data for the processing to be executed, which is defined by the processing definition information, is stored in a first memory, the first memory storing therein output data which has been obtained from raw data as a result of executing processing by a processor in accordance with processing definition information which has been generated by the generator in association with data used as the raw data and the processing definition information. An output unit outputs, if the determination unit determines that the output data associated with the processing definition information generated by the generator and the data to be used as the raw data for the processing to be executed is stored in the first memory, the output data stored in the first memory without causing the processor to execute the processing.

### BRIEF DESCRIPTION OF THE DRAWINGS

Exemplary embodiment(s) of the present invention will be described in detail based on the following figures, wherein:

FIG. 1 is a block diagram illustrating the schematic configuration of a computer in accordance with a first exemplary embodiment of the invention;

FIGS. 2A through 2C are block diagrams illustrating examples of the configuration of an image processor;

FIGS. 3A and 3B are block diagrams illustrating the schematic configuration and processing to be executed of an image processing module and those of a buffer module, respectively;

FIG. 4 is a flowchart illustrating the content of control instruction receiving execution processing executed by a control instruction receiving execution unit;

FIG. 5 is a schematic diagram illustrating the flow of image processing in an image processor;

FIG. 6 is a block diagram illustrating the schematic configuration of a computer system in accordance with a second exemplary embodiment of the invention; and

FIG. 7 is a flowchart illustrating the content of webpage distribution processing.

### DETAILED DESCRIPTION

Exemplary embodiments of the present invention will be described below in detail with reference to the accompanying drawing.

### First Exemplary Embodiment

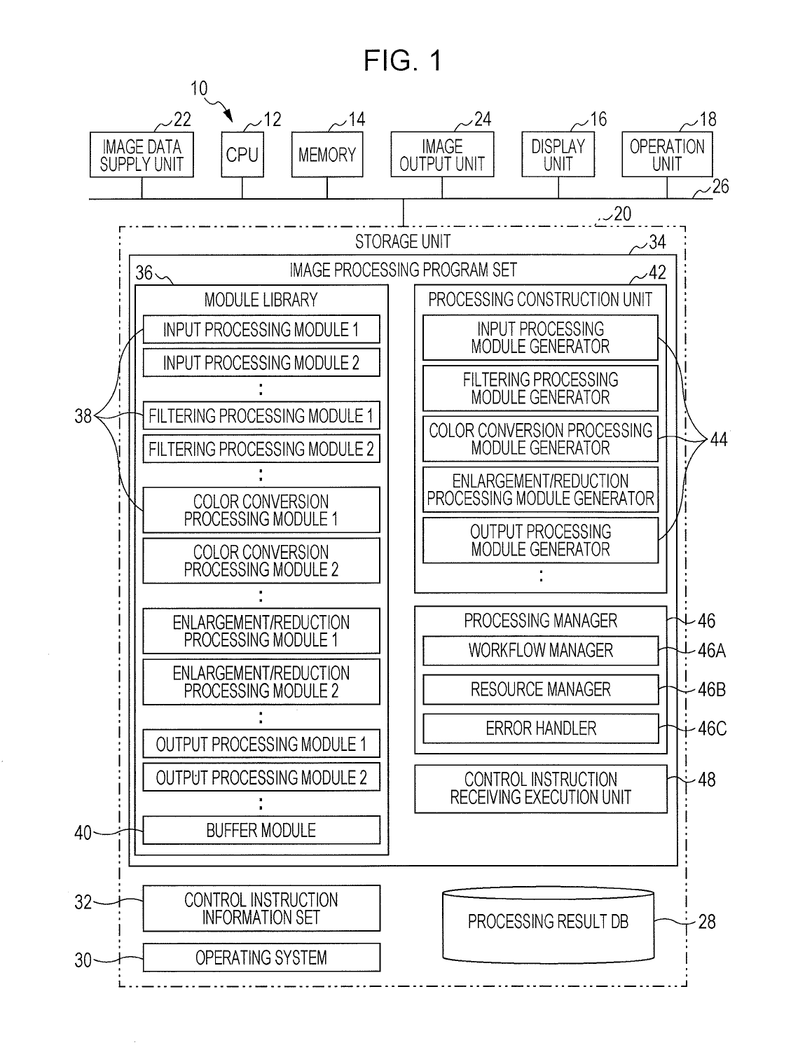

FIG. 1 illustrates a computer 10 configured to function as an information processing apparatus of a first exemplary embodiment of the invention. The computer 10 may be integrated in a certain image handling device that is necessary to perform image processing within the device, such as a copying machine, a printer, a FAX machine, an image forming device having the functions of those devices, a scanner, or a photo printer. Alternatively, the computer 10 may be an independent computer, such as a personal computer (PC), or may be a computer integrated in a portable machine, such as a personal digital assistant (PDA) or a cellular telephone.

The computer 10 includes a central processing unit (CPU) 12, a memory 14, a display unit 16, an operation unit 18, a storage unit 20, an image data supply unit 22, and an image output unit 24. Those components are connected to one another via a bus 26. If the computer 10 is integrated in the above-described image handling device, a display panel including a liquid crystal device (LCD) and a numeric keypad, which are provided in the image handling device, are used as the display unit 16 and the operation unit 18, respectively. If the computer 10 is an independent computer, a display connected to the computer 10 is used as the display unit 16, and a keyboard and a mouse connected to the computer 10 are used as the operation unit 18. As the storage unit 20, a hard disk drive (HDD) is suitably used. Alternatively, another non-volatile storage unit, such as a flash memory, may be used.

As the image data supply unit 22, any type of device may be used as long as it has the function of supplying certain image data to be subjected to processing. For example, an image reader for reading an image recorded on a recording material, such as paper or a photo film, and for outputting image data representing the read image may be used. Alternatively, a receiver for receiving image data from an external source via a communication circuit, or an image storage unit (memory 14 or storage unit 20) for storing image data, etc. may be used. As the image output unit 24, any type of device may be used as long as it has the function of outputting image data subjected to image processing or an image represented by that image data. For example, an image recorder for recording an image represented by image data on a recording material, such as paper or a photosensitive material, may be used. Alternatively, a display unit for displaying an image represented by image data on a display, etc., a writer for writing image data into a recording medium, or a sender for sending image data via a communication circuit, may be used. Alternatively, the image output unit 24 may be an image storage unit (memory 14 or storage unit 20) for simply storing image data subjected to image processing.

In the storage unit 20, as shown in FIG. 1, programs of an operating system (OS) 30, an image processing program set 34, and a processing result database (DB) 28 are stored as various programs executed by the CPU 12. The programs of the OS 30 are used for the management of the resources, such as the memory 14, and for the management of the execution of programs by the CPU 12. The programs of the OS 30 are also used for controlling communication between the computer 10 and an external source. The image processing program set 34 is used for enabling the computer 10 to function as an image processing apparatus. The processing result DB 28 is used for storing therein a control instruction information set 32 and image processing results (output data). The control instruction information set 32 indicates image processing, which is described in, for example, an XML or another format, and which is executed by the image processing apparatus that is implemented as a result of executing the image processing program set 34 by the CPU 12. It is noted that the control instruction information set 32 includes plural control instruction information items. Hereinafter, individual control instruction information items are also referred to as “control instruction information 32”.

The image processing program set 34 includes programs which have been developed for the purpose of reducing a load experienced when developing the above-described various image handling devices or cellular telephones or a load experienced when developing image processing programs that can be used in PCs, etc. Accordingly, the programs of the image processing program set 34 can be used by all platforms, such as the image handling devices, cellular telephones, and various devices, e.g., PCs. In response to an instruction from the control instruction information set 32, the image processing apparatus, which is implemented by the image processing program set 34, constructs an image processor that performs image processing described in the control instruction information 32. In this manner, the image processing apparatus performs image processing by using the image processor (details will be given later). The image processing program set 34 provides a certain interface. This interface is used for inputting, together with input data to be subjected desired image processing, the control instruction information 32 that describes the desired image processing into the image processing program set 34 so as to give an instruction to perform the desired image processing on the input data. Accordingly, when developing a certain new device in which image processing is required to be performed within the device, it is not necessary to develop a new program for performing such image processing. It is sufficient that the control instruction information set 32 which describes image processing to be performed in the new device be developed. Thus, a load experienced when developing devices and programs can be decreased.

Details of the image processing program set 34 will be described below. The image processing program set 34 includes, as shown in FIG. 1, a module library 36, a program of a processing construction unit 42, a processing manager 46, and a program of a control instruction receiving execution unit 48. Among the image processing program set 34, the program of the control instruction receiving execution unit 48, which is used for executing control instruction receiving execution processing (described later), is an example of an information processing program in accordance with an exemplary embodiment of the invention.

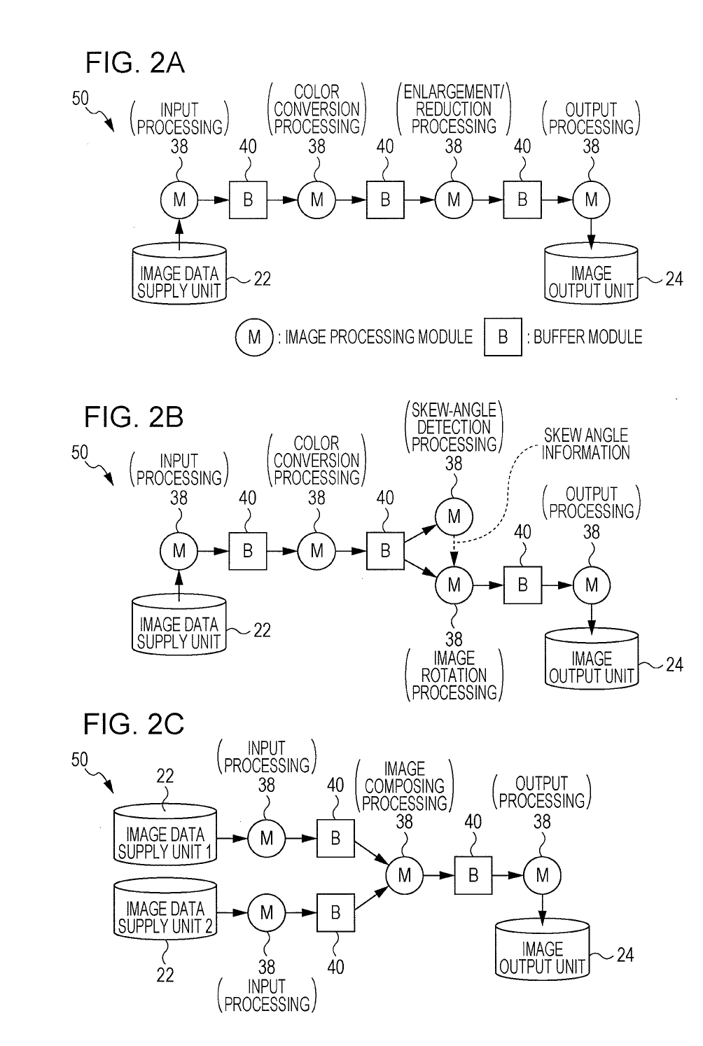

In the first exemplary embodiment, as shown in FIGS. 2A through 2C, in order to perform image processing, an image processor 50 is constructed by connecting at least one image processing module 38 and buffer modules 40 in the form of a pipeline or a DAG. The image processing module 38 performs predetermined image processing. Each of the buffer modules 40 is disposed at least at a position prior to or subsequent to the corresponding image processing module 38 and includes a buffer for storing image data therein. Image processing is performed by using the constructed image processor 50. In the first exemplary embodiment, as the control instruction information set 32, information describing desired image processing by specifying module generators 44 selected from among plural module generators 44 (discussed later) forming the processing construction unit 42 and the execution order of the selected module generators 44 is used. The module generators 44 specified by this information are module generators to be started in order to construct the image processor 50 that performs the desired image processing. The control instruction receiving execution unit 48 starts the module generators 44 specified by the input control instruction information 32 in accordance with the execution order specified by the input control instruction information 32, thereby instructing the processing construction unit 42 to construct the image processor 50.

Each of the image processing modules 38 forming the image processor 50 is, in reality, a first program or a second program. The first program is executed by the CPU 12 and causes the CPU 12 to perform image processing. The second program is executed by the CPU 12 and is used for causing the CPU 12 to instruct an external image processing apparatus (e.g., a dedicated image processing board), which is not shown in FIG. 1, to execute image processing. In the above-described module library 36, plural programs of the image processing modules 38 to perform different types of predetermined image processing operations (e.g., inputting, filtering, color conversion, enlargement/reduction, skew-angle detection, image rotation, image combining, outputting, etc.) are registered. For a simple representation, a description will be hereinafter given, assuming that each of the image processing modules 38 forming the image processor 50 is the first program.

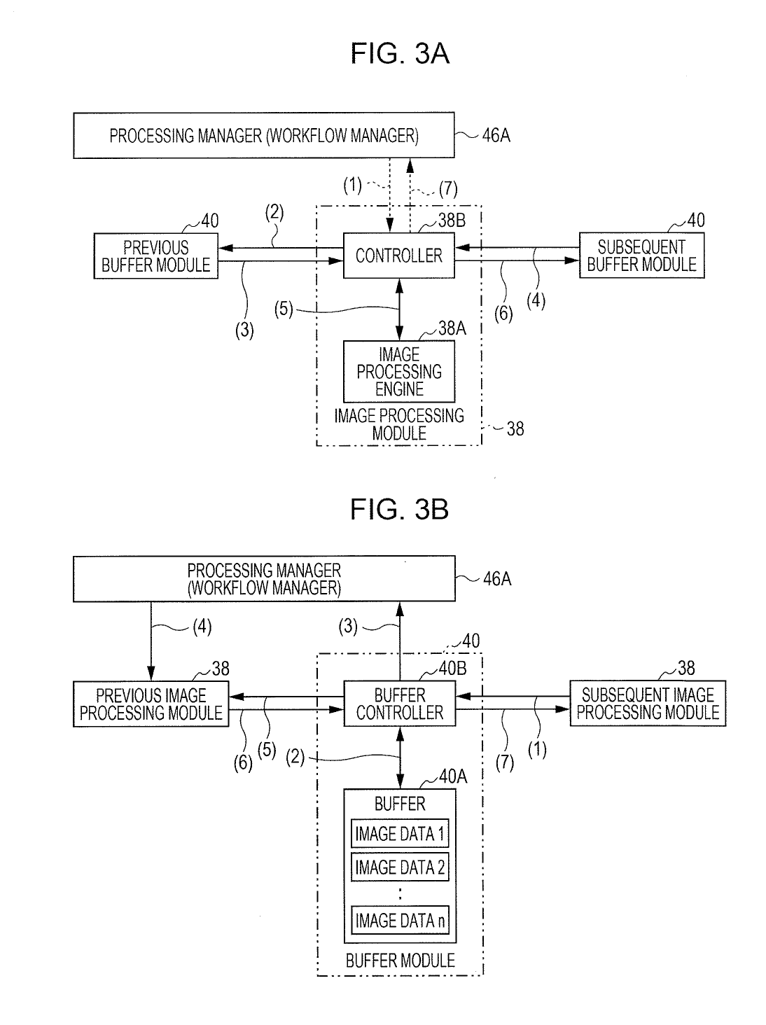

Each of the image processing modules 38 includes, as shown in FIG. 3A by way of example, an image processing engine 38A and a controller 38B. The image processing engine 38A performs image processing on image data in accordance with an amount of data to be processed at one time (during unit processing) (such an amount of data is hereinafter referred to as the “unit-processing data amount”). The controller 38B controls input and output of image data into and from the modules which are disposed prior to and subsequent to the corresponding image processing module 38, and also controls the image processing engine 38A. The unit-processing data amount handled in each of the image processing modules 38 is selected and set in advance from among one line of an image, plural lines of an image, one pixel of an image, and one frame of an image, in accordance with the type of image processing performed by the image processing engine 38A. For example, if the image processing module 38 performs color conversion processing or filtering processing, the unit-processing data amount is one pixel of an image. If the image processing module 38 performs enlargement/reduction processing, the unit-processing data amount is one line or plural lines of an image. If the image processing module 38 performs image rotation processing, the unit-processing data amount is one frame of an image. If the image processing module 38 performs image compression/decompression, the unit-processing data amount is N bytes which are determined by the execution environments.

Additionally, in the module library 36, the image processing modules 38 that perform, by using the image processing engines 38A, image processing operations whose types are the same but contents are different are also registered. In FIG. 1, such image processing modules 38 are shown as “module 1” and “module 2”. For example, the image processing modules 38 that perform enlargement/reduction processing include an image processing module 38 that reduces input image data by 50% by sampling every other pixel and an image processing module 38 that enlarges or reduces image data in accordance with a specified enlargement/reduction ratio. Also, the image processing modules 38 that perform color conversion processing include an image processing module 38 that converts from an RGB color space into a CMY color space, an image processing module 38 that converts a CMY color space into an RGB color space, and an image processing module 38 that performs another type of color conversion using, for example, an L*a*b color space.

In the image processing module 38, in order to receive image data necessary for the image processing engine 38A to perform image processing in accordance with the unit-processing data amount, the controller 38B obtains image data in accordance with an amount of data to be read at one time (such an amount of data is hereinafter referred to as the “unit read data amount”) from a module (e.g., the buffer module 40) positioned prior to the image processing module 38, and outputs image data received from the image processing engine 38A to a module (e.g., the buffer module 40) positioned subsequent to the image processing module 38 in accordance with an amount of data to be written at one time (such an amount of data is hereinafter referred to as the “unit write data amount”). In this, case, if the image processing performed in the image processing engine 38A does not involve an increase or a decrease in the data amount, such as compression, the unit write data amount is equal to the unit-processing data amount. Instead of outputting the image data to an internal module, the controller 38B outputs a result of the processing executed by the image processing engine 38A to an external source of the image processing module 38. For example, if the image processing engine 38A performs image analyzing processing, such as skew-angle detection processing, the controller 38B outputs an image analyzing processing result, such as a skew-angle detection result, instead of image data. In the module library 36, the image processing modules 38 that perform, by using the image processing engines 38A, image processing operations whose types and contents are the same but whose unit-processing data amount, unit read data amount, and unit write data amount are different are also registered. For example, the image processing modules 38 that perform image rotation processing may include, not only an image processing module 38 whose unit-processing data amount is one frame of an image, as discussed above, but also an image processing module 38 whose unit-processing data amount is one line or plural lines of an image.

The programs of each of the image processing modules 38 registered in the module library 36 include programs corresponding to the image processing engine 38A and programs corresponding to the controller 38B. The programs of the controllers 38B are modularized. For the image processing modules 38 whose unit read data amounts are the same and whose unit write data amounts are the same, the programs corresponding to the controllers 38B are modularized (i.e., the same programs are used for the controllers 38B) regardless of the types or contents of image processing operations executed in the image processing engines 38A. Accordingly, a load experienced when developing the programs corresponding to the image processing modules 38 is reduced.

The image processing modules 38 include the following types of image processing modules 38. If the attributes of an input image are unknown, the unit read data amount and the unit write data amount are indefinite. In this case, the attributes of the input image data are first obtained, and the obtained attributes are substituted into a predetermined arithmetic expression. The arithmetic expression is then calculated, thereby determining the unit read data amount and the unit write data amount. In those types of image processing modules 38, there may be some image processing modules 38 whose unit read data amounts or unit write data amounts can be determined by using the same arithmetic expression. For such image processing modules 38, programs corresponding to the controllers 38B can be modularized. As discussed above, the image processing program set 34 of this exemplary embodiment may be implemented in various devices. However, the number or the types of image processing modules 38 registered in the module library 36 of the image processing program set 34 can be added, deleted, or replaced in accordance with image processing which is necessary in a device implementing the image processing program set 34.

Each of the buffer modules 40 forming the image processor 50 includes, as shown in FIG. 3B by way of example, a buffer 40A and a buffer controller 40B. The buffer 40A is formed by a memory area which is secured in the memory 14 provided in the computer 10 through the use of the OS 30 and the resource manager 46B. The buffer controller 40B controls input and output of image data into and from the modules which are positioned prior to and subsequent to the corresponding buffer module 40, and also controls the buffer 40A. The buffer controllers 40B of the buffer modules 40 are also formed by programs executed by the CPU 12, and the programs of the buffer controllers 40B (which are shown as “buffer modules” in FIG. 1) are registered in the module library 36.

The processing construction unit 42 that constructs the image processor 50 in response to an instruction from the control instruction receiving execution unit 48 includes, as shown in FIG. 1, plural module generators 44. The plural module generators 44 correspond to different types of image processing operations, and upon being started by the control instruction receiving execution unit 48, the plural module generators 44 generate different module sets including the image processing modules 38 and the buffer modules 40, which implement the corresponding types of image processing operations. The module generators 44 shown in FIG. 1 are associated with the types of image processing operations executed by the image processing modules 38 registered in the module library 36 on the basis of a one-to-one correspondence. However, each of the module generators 44 may be associated with image processing operations implemented by plural image processing modules 38 (e.g., skew correction processing including skew-angle detection processing and image rotation processing). If the image processing implemented by the image processor 50 to be constructed includes a combination of plural types of image processing operations, the control instruction receiving execution unit 48 sequentially starts the module generators 44 corresponding to the plural types of image processing operations in accordance with the control instruction information 32. Upon being started by the control instruction receiving execution unit 48, the module generators 44 construct the image processor 50 that performs the required image processing.

The processing manager 46 includes, as shown in FIG. 1, a workflow manager 46A, a resource manager 46B, and an error handler 46C. The workflow manager 46A controls the execution of image processing performed in the image processor 50. The resource manager 46B manages the resources of the computer 10, such as the memory 14 and various files, used by the individual modules of the image processor 50. The error handler 46C handles errors occurring in the image processor 50. If an error has occurred while the image processor 50 is performing image processing, the error handler 46C handles the error as follows. The error handler 46C obtains error information concerning the type of error and where the error has occurred, and also obtains, from the storage unit 20, etc., device environment information concerning the type and configuration of a device into which the computer 10 having the image processing program set 34 is integrated. The error handler 46C then determines a manner of notifying the device of the occurrence of an error which is suitable for the device environments represented by the obtained device environment information, and then notifies the device of the occurrence of the error in accordance with the determined manner.

The operation of the first exemplary embodiment will be discussed below. If a device incorporating the image processing program set 34 encounters a situation in which certain image processing is required, the control instruction information 32 indicating image processing to be executed is input or selected, and also, image data to be subjected to image processing is input or specified, thereby starting the control instruction receiving execution unit 48.

The situations in which certain image processing is required may include situations where: a user gives an instruction to execute processing for reading an image by using an image reader, which serves as the image data supply unit 22, and for recording the image on a recording material by using an image recorder, which serves as the image output unit 24, for displaying such an input image on a display unit, which serves as the image output unit 24, for writing image data representing such an input image into a recording medium by using a writer, which serves as the image output unit 24, for sending image data representing such an input image by using a sender, which serves as the image output unit 24, or for storing image data representing such an input image in an image storage unit, which serves as the image output unit 24; and a user gives an instruction to execute processing for receiving image data by using a receiver, which serves as the image data supply unit 22, for recording image data stored in an image storage unit, which serves as the image data supply unit 22, on the above-described recording medium, for displaying the received image data on a display unit, for writing the received image data into a recording medium, sending the received image data, or for storing the received image data in an image storage unit. The situations in which certain image processing is required are not restricted to those described above. For example, the names of processing operations that can be executed by the control instruction receiving execution unit 48 in response to an instruction from a user may be displayed on the display unit 16, and the user may select a processing operation to be executed.

The control instruction information 32 and image data to be subjected to image processing (input image data) may be input or specified by an application program which is started in response to an instruction from a user. As the input image data, image data obtained as a result of reading an image by an image reader, which serves as the image data supply unit 22, image data received by a receiver, which serves as the image data supply unit 22, or image data stored in an image storage unit, which serves as the image data supply unit 22, may be input or specified. As the control instruction information 32, one information item may be selected from the control instruction information set 32 stored in the storage unit 20, or the control instruction information 32 which is received, together with input image data, by a receiver, which serves as the image data supply unit 22, may be input.

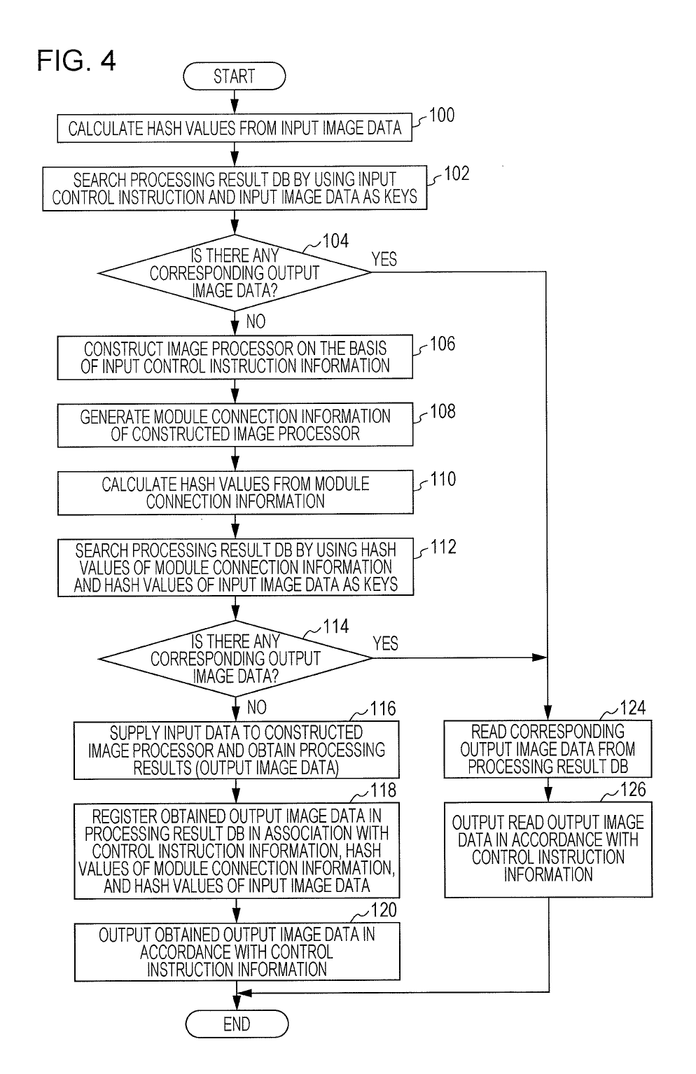

Upon inputting (or selecting) the control instruction information 32 and upon inputting (or specifying) input image data, the control instruction receiving execution unit 48 performs control instruction receiving execution processing shown in FIG. 4. In the control instruction receiving execution processing, in step 100, hash values are calculated from the input image data, which has been input or specified to be subjected to image processing, by using hash functions. It is noted that the input image data corresponds to an example of raw data used in an exemplary embodiment of the invention, and that the hash values calculated from the input image data correspond to an example of raw data identification information used in an exemplary embodiment of the invention.

The processing result DB 28 of the first exemplary embodiment is a DB in which image data elements (output image data elements) obtained as a result of performing image processing by the image processors 50 which were previously constructed in accordance with the input control instruction information items 32 are registered in association with the hash values of the input image data elements, the input control instruction information items 32, and the hash values of module connection information, which will be discussed later. In step 102, the processing result DB 28 is searched by using the input control instruction information 32 and the hash values calculated in step 100 as keys. In step 104, it is determined whether output image data associated with the above-described control instruction information 32 and the hash values of the input image data is registered in the processing result DB 28. It is noted that steps 102 and 104 correspond to processing executed by a determination unit used in an exemplary embodiment of the invention.

Step 104 is executed to determine whether image processing was previously executed by using a combination of the currently input control instruction information 32 and the input image data to be executed. If the result of step 104 is NO, the process proceeds to step 106. In step 106, a thread for executing the program of the workflow manager 46A is first started, and then, the module generators 44 specified by the currently input control instruction information 32 are started in the execution order specified by the currently input control instruction information 32. Accordingly, the image processor 50 that implements image processing described in the currently input control instruction information 32 is constructed by the processing construction unit 42.

The construction of the image processor 50 will be described below. The control instruction receiving execution unit 48 first generates, as the image data supply unit 22, a buffer module 40 including a buffer region (part of the memory 14) in which input image data is stared. When generating a new buffer module 40, a buffer controller 40B is generated by starting a thread (a process or an object, which applies to the following description) for executing the program of the buffer controller 40B of the buffer module 40, and the generated buffer controller 40B secures a memory area, which serves as the buffer 40A. In this case, a parameter is set to allow the buffer controller 40B to identify that a buffer region storing the input image data therein has already been secured in the buffer 40A, and then, the buffer controller 40B is generated. The generated buffer module 40 functions as the image data supply unit 22.

Similarly, the control instruction receiving execution unit 48 identifies the type of image output unit 24 to which image data subjected to image processing is output. If the identified type is a buffer region (part of the memory 14), a buffer module 40 including a buffer region specified as the image output unit 24 is generated in a manner similar to that when the buffer module 40, which serves as the image data supply unit 22, is generated. The buffer module 40 generated as described above functions as the image output unit 24.

The control instruction receiving execution unit 48 starts the module generator 44 (generates a thread for executing the program of the module generator 44). This module generator 44 is to be started first in the execution order specified by the input control instruction information 32. The control instruction receiving execution unit 48 then supplies information necessary for generating a module set by the started module generator 44 to the model generator 44. Such information includes input module identification (ID) information for identifying an input module that inputs image data to the module set, output module identification (ID) information for identifying an output module to which the module set outputs the image data, input image attribute information concerning attributes of the image data to be input into the module set, and parameters for image processing to be executed. In this manner, the control instruction receiving execution unit 48 repeats processing for instructing the second and subsequent module generators 44 to generate the corresponding module sets.

Concerning the above-described input module, the image data supply unit 22 serves as the input module for the module set generated by the first module generator 44 which is executed first in the execution order. For each of the module sets generated by the second and subsequent module generators 44 which are subsequently executed in the execution order, the final module (normally buffer module 40) of the previous module set serves as the input module. Concerning the above-described output module, the image output unit 24 serves as the output module for the final module set generated by the module set which is executed last in the execution order. However, for the other module sets, output modules are undefined, and thus, the control instruction receiving execution unit 48 does not specify output modules, and if necessary, the module generators 44 generate and set output modules.

Each of the module generators 44 started by the control instruction receiving execution unit 48 first obtains input image attribute information concerning the attributes of input image data to be input into an image processing module 38 to be generated. If there is a buffer module 40 positioned prior to the image processing module 38 to be generated, the attributes of input image data can be obtained from the attributes of output image data output from the image processing module 38 positioned prior to that buffer module 40.

It is then determined whether it is necessary to generate a buffer module 40 at a position subsequent to the image processing module 38 to be generated. This determination may be made as follows. If an output module (image output unit 24) is positioned subsequent to the image processing module 38 to be generated (e.g., see the final image processing module 38 in the image processor 50 shown in FIGS. 2A through 2C), or if an image processing module 38 performs image processing (e.g., analysis) on image data and outputs an image processing (analysis) result to another image processing module 38, such as the image processing module 38 for performing skew-angle detection processing in the image processor 50 shown in FIG. 2B, it is determined that it is not necessary to generate a buffer module 40. However, except for the above-described cases, it is determined that it is necessary to generate a buffer module 40. Then, the control instruction receiving execution unit 48 starts the buffer controller 40B (generates a thread for executing the program of the buffer controller 40B) so as to generate a buffer module 40 which is to be connected to the image processing module 38 (subsequent to the image processing module 38).

Then, the module generator 44 generates an image processing module 38 by supplying information concerning the previous module (e.g., buffer module 40), information concerning the subsequent buffer module 40, the attributes of input image data to be input into the image processing module 38, and processing parameters. It is noted that information concerning the subsequent buffer module 40 is not supplied to an image processing module 38 for which the generation of the subsequent buffer module 40 is not necessary. Also, if special image processing parameters are not necessary since the processing content of an image information module 38 is fixed, e.g., 50% reduction processing, processing parameters are not supplied to such an image processing module 38.

The module generator 44 selects, from among plural. candidate modules that are registered in the module library 36 and that can be used as the image processing module 38, the image processing module 38 that matches the obtained attributes of the input image data and the processing parameters to be executed in the image processing module 38. It is now assumed that the module generator 44 is a module generator that generates a module set for performing color conversion, and that a CMY color space is specified as the color space of output image data by the control instruction receiving execution unit 48 using the image processing parameters and the input image data is RGB color space data. In this case, from among plural image processing modules 38 that are registered in the module library 36 and that perform various types of color conversion processing operations, the image processing module 38 that performs RGB→CMY color space conversion is selected and generated.

If the image processing module 38 is an image processing module that performs enlargement/reduction processing and if the specified enlargement/reduction ratio is other than 50%, the image processing generator 38 that performs enlargement/reduction processing with a specified enlargement/reduction ratio is selected and generated. If the specified reduction ratio is 50%, the image processing module 38 that performs reduction processing with a reduction ratio 50%, i.e., the image processing module 38 that reduces input image data by 50% by sampling every other pixel, is selected and generated. The selection of the image processing module 38 is not restricted to the above-described examples. For example, the unit-processing data amount in the image processing performed by the image processing engines 38A may be different among the image processing modules 38. Such image processing modules 38 may be registered in the module library 36. Then, the image processing module 38 having a suitable unit-processing data amount is selected in accordance with the operating environments, such as the size of a memory area which can be assigned to the image processor 50. For example, as the size of the memory area decreases, the image processing module 38 having a smaller unit-processing data amount is selected. If the module generator 44 generates a module set for performing image processing implemented by plural image processing modules 38 (e.g., skew correction processing implemented by the image processing module 38 that performs skew-angle detection processing and the image processing module 38 that performs image rotation processing), the above-described processing is repeated so as to generate a module set including two or more image processing modules 38.

The module generator 44 then notifies the workflow manager 46A of a set of the ID of the subsequent buffer module 40 and the ID of the generated image processing module 38. Any type of information may be given to those IDs as long as the individual modules can be uniquely identified. For example, the numbers assigned to the individual modules in the order in which the modules have been generated, or addresses assigned to the objects forming the buffer module 40 and the image processing module 38 in the memory 14 may be used. The information supplied to the workflow manager 46A is registered in a management table managed in the workflow manager 46A, and is used for subsequent processing. The IDs of the modules may be stored in the form of a list or an associative array instead of a table.

By sequentially executing the above-described processing by the individual module generators 44 that are sequentially started by the control instruction receiving execution unit 48, the image processor 50 that performs required image processing is constructed as shown in FIGS. 2A through 2C.

Upon completion of the construction of the image processor 50 as described above, in step 108, module connection information indicating the configuration of the image processor 50 generated by the started module generator 44 of the processing construction unit 42 is generated. The module connection information indicates the number and the types of image processing modules 38 forming the image processor 50, the connection relationship among the image processing modules 38 and the buffer modules 40, etc. It is noted that the module connection information corresponds to an example of processing definition information, and more specifically, an example of information concerning the connection relationship among the processing modules in accordance with an exemplary embodiment of the invention. It is also noted that steps 106 and 108 correspond to an example of processing of a generator in accordance with an exemplary embodiment of the invention.

In step 110, hash values are calculated from the module connection information generated in step 108 by using hash functions. It is noted that the hash values correspond to an example of processing definition information identification information in accordance with an exemplary embodiment of the invention. In step 112, the processing result DB 28 is searched by using the hash values of the module connection information calculated in step 110 and the hash values of the input image data calculated in step 100 as keys. Then, in step 114, it is determined whether output image data associated with the hash values of the module connection information and the hash values of the input image data is registered in the processing result DB 28. It is noted that steps 112 and 114 correspond to an example of processing executed by the determination unit in accordance with an exemplary embodiment of the invention.

Step 114 is executed to determine whether image processing was previously executed on the currently input image data by the image processor 50 having the same configuration as the image processor 50 indicated by the module connection information generated in step 108. If the result of step 114 is NO, the process proceeds to step 116. In step 116, the control instruction receiving execution unit 48 instructs the workflow manager 46A of the processing manager 46 to execute image processing on the input image data by using the image processor 50.

Then, the workflow manager 46A of the processing manager 46 causes the CPU 12 to execute in parallel plural threads for executing the program of the image processor 50 which has been generated by the processing construction unit 42. The workflow manager 46A also inputs a processing request into the final image processing module 38 of the image processor 50. Additionally, every time a data request is received from a certain buffer module 40, the workflow manager 46A inputs a processing request into the image processing module 38 positioned prior to the buffer module 40 that has sent the data request. Also, every time a processing completion notification is received from a certain image processing module 38, the workflow manager 46A inputs a processing request into the image processing module 38 that has sent the processing completion notification. This processing is repeated until an entire-processing completion notification is received from the final image processing module 38 (until image processing of one frame of image data is completed).

As shown in FIG. 3A, every time a processing request is received from the workflow manager 46A (see (1) of FIG. 3A), each image processing module 38 of the image processor 50 performs the following processing. The image processing module 38 first requests the previous buffer module 40 to supply image data (see (2) of FIG. 3A) and reads the unit-processing data amount of image data from the previous buffer module 40 (see (3) of FIG. 3A). Then, the image processing module 38 obtains a write area for the image data from the subsequent buffer module 40 (see (4) of FIG. 3A). The image processing module 38 then performs image processing on the image data read from the previous buffer module 40 by using the image processing engine 38A (see (5) of FIG. 3A), and outputs the image data subjected to the image processing to the subsequent buffer module 40 (see (6) of FIG. 3A). Then, the image processing module 38 supplies a processing completion notification to the workflow manager 46A (see (7) of FIG. 3A).

As shown in FIG. 3B, every time a request to supply image data is received from the subsequent image processing module 38 (see (1) of FIG. 3B), each buffer module 40 of the image processor 50 performs the following processing. The buffer module 40 first checks whether the requested image data is stored in the buffer 40A of the buffer module 40 (see (2) of FIG. 3B). If the requested image data is not stored in the buffer 40A, the buffer module 40 requests the workflow manager 46A to supply image data (see (3) of FIG. 3B). A processing request is input into the previous image processing module 38 from the workflow manager 46A (see (4) of FIG. 3B), and then, the buffer module 40 supplies information concerning a write area to the previous image processing module 38 (see (5) of FIG. 3B), and image data is written into the buffer 40A from the previous image processing module 38 (see (6) of FIG. 3B). Then, the buffer module 40 causes the subsequent image processing module 38 to read the image data written into the buffer 40A (see (7) of FIG. 3B).

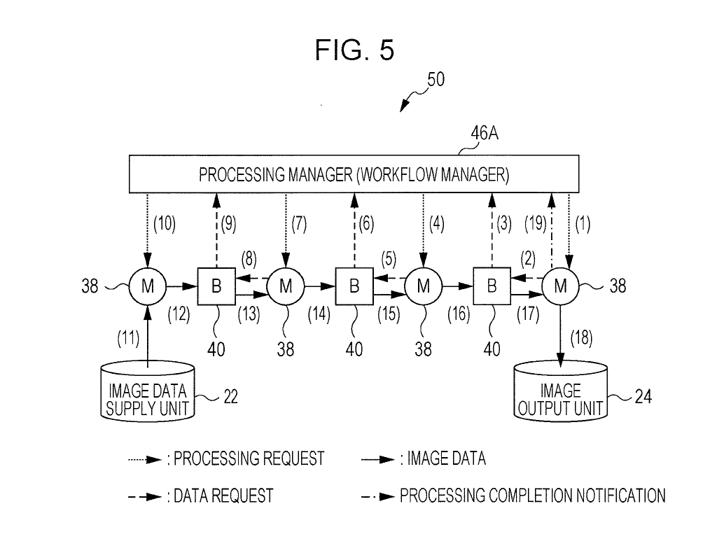

With this processing, as shown in (1) through (19) of FIG. 5 by way of example, by sending and receiving image data, processing requests, data requests, and processing completion notifications between the workflow manager 46A and the individual modules of the image processor 50 and also among the individual modules of the image processor 50, image processing is performed in the individual image processing modules 38 in parallel. As a result, the image processor 50 performs the image processing described in the control instruction information 32 on input image data stored in the buffer of the image data supply unit 22, and stores the processing results (output image data) in the buffer of the image output unit 24. It is noted that step 116 corresponds to an example of processing executed by the processor in accordance with an exemplary embodiment of the invention.

In step 118, the output image data obtained in step 116 is registered in the processing result DB 28 in association with the currently input control instruction information 32, the hash values of the module connection information, and the hash values of the input image data. In step 120, the output image data obtained in step 116 is output (for example, by recording an image on a recording material, displaying an image on a display unit, writing image data into a recording medium, sending image data, or storing image data in an image storage unit) in accordance with the control instruction information 32. Then, the control instruction receiving execution processing is completed.

If image processing by a combination of the currently input control instruction information 32 and the input image data was executed previously, in step 102, the output image data associated with the currently input control instruction information 32 and the hash values of the input image data is extracted from the processing result DB 28. Thus, the result of step 104 is YES. Even if the result of step 104 is NO, if image processing was executed previously on the input image data by using the image processor 50 having the same configuration as the image processor 50 indicated by the module connection information, in step 112, the output image data associated with the hash values of the module connection information and the hash values of the input image data is extracted from the processing result DB 28. Thus, the result of step 114 is YES.

The case where the result of step 104 is NO and the result of step 114 is YES may be the case where a description of the currently input control instruction information 32 is different from that of a previously input control instruction information 32, despite that the current image processing to be performed is the same as the previous image processing (despite that the configuration of the image processor 50 for performing the current image processing is the same as that of the image processor 50 for performing the previous image processing). In the first exemplary embodiment, the control instruction information 32 is described in an XML, etc. Thus, a certain variation in descriptions of control instruction information 32 is allowed even if the contents of image processing indicated by the control instruction information items 32 are the same. It is thus possible that, even if the contents of image processing indicated by the currently input control, instruction information 32 are the same as those indicated by the previously input control instruction information 32 (the configurations of the image processors 50 for implementing that image processing are the same), the descriptions of the two control instruction information items 32 may be different. In contrast, in the control instruction receiving execution processing in accordance with the first exemplary embodiment, the processing result DB 28 is re-searched by using the hash values of the module connection information. Accordingly, even if the descriptions of. the control instruction information items 32 are different, it can be detected that the output image data stored in the processing result DB 28 can be used if the control instruction information 32 indicating the same image processing (the same configuration of the image processor 50) as that of the previously control instruction information 32 is input and if the input image data is the same.

If the result of step 104 or 114 is YES, the process proceeds to step 124. In step 124, the output image data extracted as a result of searching the processing result DB 28 in step 102 or 112 is read from the processing result DB 28. Then, in step 126, the output image data read from the processing result DB 28 is output in accordance with the control instruction information 32. The control instruction receiving execution processing is then completed. In this case, image processing by using the image processor 50 is not performed, and thus, output image data associated with the input control instruction information 32 and input image data can be promptly output, and a load applied to the computer 10 is also reduced. It is noted that steps 124 and 126 correspond to an example of processing executed by an output unit in accordance with an exemplary embodiment of the invention.

### Second Exemplary Embodiment

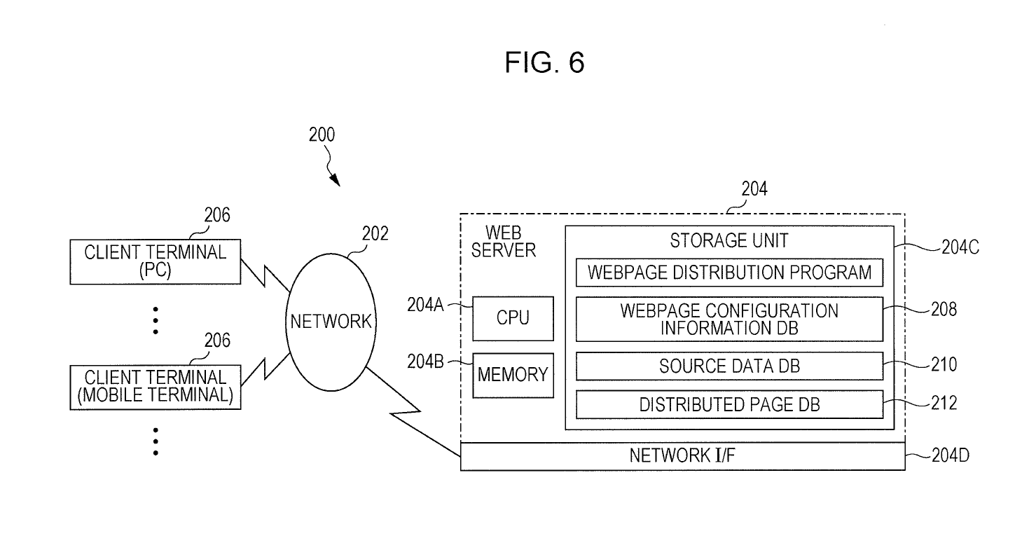

A second exemplary embodiment of the invention will be described below. FIG. 6 illustrates a computer system 200 in accordance with the second exemplary embodiment. The computer system 200 is constructed by connecting a web server 204 and plural client terminals 206 to a network 202. The network 202 may be the Internet or an intranet.

The web server 204 includes a CPU 204A, a memory 204B containing a read only memory (ROM) and a random access memory (RAM), a non-volatile storage unit 204C, such as an HDD or a flash memory, and a network interface (I/F) 204D. The web server 204 is connected to the network 202 via the network I/F 204D. In the storage unit 204C, a webpage distribution program for enabling the web server 204 to perform webpage distribution processing, which will be discussed later, is installed. In the storage unit 204C, a webpage configuration information DB 208, a source data DB 210, and a distributed page DB 212 are also stored (details of which will be discussed later).

The client terminals 206 may be any one of a desktop PC, a notebook PC, a PDA, a cellular telephone, etc. The client terminals 206 have different display environments, such as the size and the resolution (the number of pixels) of the display, and the number of gradation levels (the number of bits assigned to each pixel of display data). In this manner, the display environments of the client terminals 206 connected to the network 202 may be different.

The operation of the second exemplary embodiment is as follows. In the computer system 200, in response to a request from one of the client terminals 206, the web server 204 distributes webpage data to the client terminal 206 that has sent the request. A webpage distribution request can be sent from one of the client terminal 206 to the web server 204 by sending control instruction information from the client terminal 206 to the web server 204. The control instruction information describes, in an XML or another format, a uniform resource locator (URL) of a webpage to be distributed and display environment information indicating the display environments of the display of the client terminal 206.

In the source DB 210 stored in the storage unit 204C of the web server 204, plural source data elements (e.g., document data, image data, table data, etc.) used for generating individual webpages to be distributed by the web server 204 are stored. In the webpage configuration information DB 208 stored in the storage unit 204C of the web server 204, webpage configuration information including information for specifying the layout of a webpage and specifying source data to be attached to individual sections forming the webpage is registered for each of the webpages to be distributed by the web server 204 in association with the URLs of the corresponding webpages.

In the distributed page DB 212 stored in the storage unit 204C of the web server 204, data elements of webpages that were previously distributed from the web server 204 to any of the client terminals 206 are registered in association with control instruction information received from the client terminals 206, the hash values of the source data used for generating the distributed webpages, and the hash values of page generating processing codes (details of which will be discussed later) used for generating data of the distributed webpages.

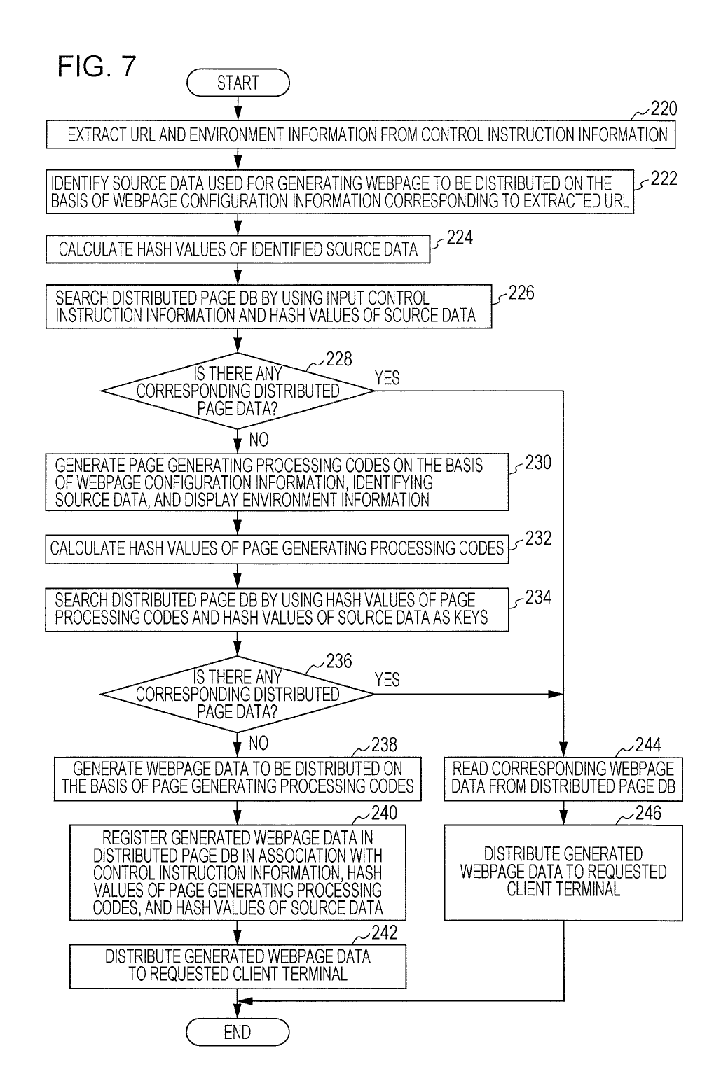

The webpage distribution processing will now be described with reference to FIG. 7. The webpage distribution processing is implemented by executing the webpage distribution program by the CPU 204A every time control instruction information is received by the web server 204 from any one of the client terminals 206 of the computer system 200.

In the web distribution processing, in step 220, the URL and display environment information of a webpage to be distributed are extracted from control instruction information received from one of the client terminals 206. Then, in step 222, the webpage configuration information DB 208 is searched by using the URL extracted from the control instruction information in step 220 as a key so as to read the webpage configuration information corresponding to the webpage to be distributed from the webpage configuration information DB 208. Then, the source data DB 210 is searched to identify the source data used for generating a webpage to be distributed on the basis of the read webpage configuration information.

In step 224, the source data identified in step 222 is read from the source data DB 210 so as to calculate the hash values of the read source data. If there are plural source data elements used for generating a webpage to be distributed, the source data element for which the hash values are to be calculated is selected in accordance with preset rules, for example, the source data element to be attached to a position closest to the head of the webpage is selected. In step 226, the distributed page DB 212 is searched by using the control instruction information received from the client terminal 206 and the hash values of the source data calculated in step 224. In step 228, it is determined whether the data of a distributed webpage associated with the control instruction information and the hash values of the source data is registered in the distributed page DB 212. It is noted that steps 226 and 228 correspond to processing executed by a determination unit in accordance with an exemplary embodiment of the invention.

Step 228 is executed to determine whether webpage data associated with a combination of the currently input control instruction information and the source data used for generating a webpage requested by the client terminal 206 was distributed previously to one of the client terminals 206. If the result of step 228 is NO, the process proceeds to step 230. In step 230, processing codes (page generating processing codes) for generating the webpage are generated on the basis of the webpage configuration information read from the webpage configuration information DB 208 in step 222, the source data identified in step 222, and the display environment information extracted from the control instruction information in step 220.

In step 230, processing codes for causing the CPU 204A to execute processing for generating a webpage to be distributed are generated. More specifically, such processing including generating a background image and attaching source data to a webpage to be distributed. The processing also includes setting the page size and converting the source data (e.g., changing the character size and changing the resolution and the number of gradation levels of an image) in accordance with the display environments of the display of the client terminal 206 that has sent a webpage distribution request. It is noted that step 230 corresponds to processing executed by a generator in accordance with an exemplary embodiment of the invention.

In step 232, the hash values of the page generating processing codes generated in step 230 are calculated. In step 234, the distributed page DB 212 is searched by using the hash values of the page generating processing codes calculated in step 232 and the hash values of the source data calculated in step 224 as keys. In step 236, it is determined whether the data of a distributed webpage associated with the hash values of the page generating processing codes and the hash values of the source data is registered in the distributed page DB 212. It is noted that steps 234 and 236 correspond to processing executed by a determination unit in accordance with an exemplary embodiment of the invention.

Step 236 is executed to determine whether webpage data associated with a combination of the currently generated page generating processing codes and the source data used for generating a webpage requested by the client terminal 206 was distributed previously to one of the client terminals 206. If the result of step 236 is NO, the process proceeds to step 238. In step 238, the CPU 204A executes the page generating processing codes generated in step 230 so as to generate webpage data to be distributed. It is noted that step 238 corresponds to processing executed by a processor in accordance with an exemplary embodiment of the invention.

In step 240, the webpage data generated in step 238 is registered in the distributed page DB 212 in association with the currently input control instruction information, the hash values of the page generating processing codes calculated in step 232, and the hash values of the source data calculated in step 224. In step 242, the webpage data generated in step 238 is sent (distributed) to the client terminal 206 that has sent a distribution request. The webpage distribution processing is then completed.

If the data of a distributed webpage associated with a combination of the currently input control instruction information and the hash values of the source data used for generating the webpage to be distributed was previously distributed to one of the client terminals 206, the distributed webpage data associated with the currently input control instruction information and the hash values of the source data is extracted from the distributed page DB 212 in step 226. Accordingly, the result of step 228 is YES. Even if the result of step 228 is NO, if webpage data associated with the page generating processing codes generated in step 230 and the source data used for generating the webpage was distributed previously to one of the client terminals 206, in step 234, the distributed webpage data associated with the hash values of the page generating processing codes and the hash values of the source data is extracted from the distributed page DB 212. Thus, the result of step 236 is YES.

The case where the result of step 228 is NO and the result of step 236 is YES may be the case where a request to distribute the same webpage has been sent from the client terminals 206 whose display environments are slightly different. In the second exemplary embodiment, display environment information indicating the display environments is contained in the control instruction information. Accordingly, control instruction information items sent from the client terminals 206 having slightly different display environments are partially different even if they contain a request to distribute the same webpage. However, if there are only a slight difference between the display environments of displays, the same webpage data (and page generating processing codes for generating the webpage data) may be distributed to the client terminals 206.

In contrast, in the webpage distribution processing in accordance with the second exemplary embodiment of the invention, the distributed page DB 212 is re-searched by using the hash values of the page generating processing codes. Thus, even if the display environment information contained in the control instruction information sent from a client terminal 206 that has sent a request to distribute a webpage is slightly different from that sent from another client terminal 206 that previously sent a request to distribute the same webpage, it is still possible to send the same webpage stored in the distributed page DB 212 to the client terminal 206 that has sent a request.

If the result of step 228 or 236 is YES, the process proceeds to step 244. In step 244, the distributed webpage data extracted in step 226 or 234 is read from the distributed page DB 212. In step 246, the distributed webpage data read from the distributed page DB 212 is sent (distributed) to the client terminal 206 that has sent the webpage distribution request. Then, the webpage distribution processing is completed. In this case, processing for generating webpage data is not performed, and thus, in response to a request to distribute a webpage by using the received control instruction information, the corresponding webpage data can be promptly output, and a load applied to the web server 204 is also reduced. It is noted that steps 244 and 246 correspond to processing executed by an example of an output unit in accordance with an exemplary embodiment of the invention.

In the first exemplary embodiment, output image data is registered in the processing result DB 28 in association with the hash values of input image data, the input control instruction information 32, and the hash values of module connection information. However, this is an example only. Instead of the hash values of input image data, the input image data itself may be stored in the processing result DB 28, and instead of the hash values of module connection information, the module connection information itself may be stored in the processing result DB 28. Alternatively, instead of module connection information, program execution codes which function as the image processor 50, or the hash values of the program execution codes may be stored in the processing result DB 28 and may be used for a search. Also, steps 102 and 104 of the control instruction receiving execution processing (FIG. 4) described in the first exemplary embodiment may be omitted, in which case, the storage of the control instruction information 32 in the processing result DB 28 may also be omitted.

In the second exemplary embodiment, distributed webpage data is registered in the distributed page DB 212 in association with the input control instruction information 32, the hash values of source data used for generating webpage data, and the hash values of page generating processing codes. However, this is an example only. Instead of the hash values of source data, the source data itself may be stored in the distributed page DB 212, and instead of the hash values of page generating processing codes, the page generating processing codes themselves may be stored in the distributed page DB 212. Also, steps 226 and 228 of the webpage distribution processing (FIG. 7) described in the second exemplary embodiment may be omitted, in which case, the storage of the control instruction information 32 in the distributed page DB 212 may also be omitted.

In the second exemplary embodiment, when generating webpage data to be distributed, the source data is converted in accordance with the display environments of the display of a client terminal 206 that has sent a request to distribute a webpage. However, this is an example only. Source data elements indicating the same object (document, image, table, etc.) may be prepared in advance in accordance with plural display environments and may be stored in the source data DB 210. Then, when generating webpage data to be distributed, the source data element which is suitable for the display environments of the display of the client terminal 206 that has sent a request to distribute the webpage may be selected.

In the first exemplary embodiment, the storage unit 20 of the computer 10, which functions as the information processing apparatus according to an exemplary embodiment of the invention, serves as a first memory. In the second exemplary embodiment, the storage unit 204C of the web server 204, which functions as the information processing apparatus according to an exemplary embodiment of the invention, serves as the first memory. However, the storage units 20 and 204C are examples only. A storage unit, which is accessed by another information processing apparatus (e.g., a DB server) connected to the information processing apparatus according to an exemplary embodiment of the invention via a communication circuit, such as a network, may function as the first memory, and may store therein the processing result DB 28 discussed in the first exemplary embodiment or the distributed page DB 212 discussed in the second exemplary embodiment.

In the first exemplary embodiment, the computer 10 functions as the information processing apparatus or the processor according to an exemplary embodiment of the invention. In the second exemplary embodiment, the web server 204 functions as the information processing apparatus or the processor according to an exemplary embodiment of the invention. Alternatively, a virtual machine which is implemented or provided by a server farm, incorporating a cloud computing technology, installed in a data center may function as at least one of the information processing apparatus or the processor according to an exemplary embodiment of the invention.

As processing for obtaining output data from raw data described in control instruction information, image processing for obtaining output image data from input image data has been discussed by way of example in the first exemplary embodiment, and processing for generating webpage data from source data has been discussed by way of example in the second exemplary embodiment. However, any type of processing for obtaining output data from raw data may be applied.

In the first exemplary embodiment, the program that realizes the control instruction receiving execution unit 48, which is an example of the information processing program of an exemplary embodiment of the invention, has been stored (installed) in advance in the storage unit 20 of the computer 10. In the second exemplary embodiment, the webpage distribution program, which is an example of the information processing program of an exemplary embodiment of the invention, has been stored (installed) in advance in the storage unit 204C of the web server 204. Alternatively, the information processing program of an exemplary embodiment of the invention may be recorded on a recording medium, such as a compact disc (CD)-ROM or a digital versatile disk (DVD)-ROM, and may be provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a generator that generates, on the basis of instruction information which describes processing to be executed for obtaining output data from raw data, processing definition information that defines details of the processing, upon inputting the instruction information from a processing request source;
a determination unit that makes a determination regarding whether output data associated with the processing definition information generated by the generator and associated with data to be used as raw data for the processing to be executed, which is defined by the processing definition information, is stored in a first memory, the first memory storing therein output data which has been obtained from raw data as a result of executing processing by a processor in accordance with processing definition information which has been generated by the generator in association with data used as the raw data and the processing definition information; and
an output unit that outputs, if the determination unit determines that the output data associated with the processing definition information generated by the generator and the data to be used as the raw data for the processing to be executed is stored in the first memory, the output data stored in the first memory without causing the processor to execute the processing.

2. The information processing apparatus according to claim 1, wherein:
in the first memory, the output data which has been obtained is stored in association with the data used as the raw data, the processing definition information which has been generated by the generator, and instruction information which has been input;
the determination unit makes a determination regarding whether output data associated with the instruction information which describes processing to be executed and associated with data to be used as the raw data for the processing to be executed is stored in the first memory, and if the determination unit determines that the output data is not stored in the first memory, the determination unit makes a determination regarding whether output data associated with the processing definition information generated by the generator and associated with data to be used as the raw data for the processing to be executed is stored in the first memory; and
the output unit outputs, if the determination unit determines that the output data associated with the instruction information which describes processing to be executed and associated with data to be used as the raw data for the processing to be executed is stored in the first memory, the output data stored in the first memory without causing the processor to execute the processing.

3. The information processing apparatus according to claim 1, wherein:
raw data identification information is stored in the first memory as data used as the raw data, and the raw data identification information is uniquely determined by the data used as the raw data; and
the determination unit obtains the raw data identification information from the data to be used as the raw data for the processing to be executed, and makes the determination by using the obtained raw data identification information.

4. The information processing apparatus according to claim 1, wherein:
processing definition information identification information is stored in the first memory as the processing definition information, and the processing definition information identification information is uniquely determined by the processing definition information; and
the determination unit obtains the processing definition information identification information from the processing definition information generated by the generator, and makes the determination by using the obtained processing definition information identification information.

5. The information processing apparatus according to claim 1, wherein:
when, as a processing unit that implements the processing described in the instruction information, a construction unit constructs in the form of a pipeline or a directed acyclic graph, on the basis of the instruction information, a processing unit by connecting at least one processing module selected from among a plurality of processing modules that perform different processing operations, the generator generates information indicating a connection relationship among the at least one processing module in the constructed processing unit as the processing definition information; and
the processor executes the processing described in the instruction information by using the constructed processing unit.

6. The information processing apparatus according to claim 1, wherein data to be used as the raw data for the processing to be executed is input from the processing request source or is specified by the processing request source from among a plurality of data elements stored in a second memory.

7. The information processing apparatus according to claim 1, wherein:
the instruction information also describes environment information indicating environments of the processing request source; and
the generator differentiates the details of the processing defined by the processing definition information in accordance with the environments of the processing request source indicated by the environment information described in the instruction information.

8. The information processing apparatus according to claim 7, wherein:
a second memory for storing therein a plurality of data elements to be used as raw data is provided; and
the generator selects data to be used as the raw data for the processing to be executed from among the plurality of data elements stored in the second memory in accordance with the environments of the processing request source indicated by the environment information.

9. An information processing apparatus comprising:
a generator that generates, on the basis of instruction information which describes processing to be executed for obtaining output data from raw data, processing definition information that defines details of the processing, upon inputting the instruction information from a processing request source;
a determination unit that makes a determination regarding whether output data associated with the instruction information which describes processing to be executed and associated with data to be used as raw data for the processing to be executed is stored in a first memory, the first memory storing therein output data which has been obtained from raw data as a result of executing processing by a processor in accordance with processing definition information which has been generated by the generator in association with data used as the raw data and instruction information which has been input; and
an output unit that outputs, if the determination unit determines that the output data associated with the instruction information which describes processing to be executed and the data to be used as the raw data for the processing to be executed is stored in the first memory, the output data stored in the first memory without causing the processor to execute the processing.

10. The information processing apparatus according to claim 9, wherein:
when, as a processing unit that implements the processing described in the instruction information, a construction unit constructs in the form of a pipeline or a directed acyclic graph, on the basis of the instruction information, a processing unit by connecting at least one processing module selected from among a plurality of processing modules that perform different processing operations, the generator generates information indicating a connection relationship among the at least one processing module in the constructed processing unit as the processing definition information; and
the processor executes the processing described in the instruction information by using the constructed processing unit.

11. The information processing apparatus according to claim 9, wherein data to be used as the raw data for the processing to be executed is input from the processing request source or is specified by the processing request source from among a plurality of data elements stored in a second memory.

12. The information processing apparatus according to claim 9, wherein:
the instruction information also describes environment information indicating environments of the processing request source; and
the generator differentiates the details of the processing defined by the processing definition information in accordance with the environments of the processing request source indicated by the environment information described in the instruction information.

13. The information processing apparatus according to claim 12, wherein:
a second memory for storing therein a plurality of data elements to be used as raw data is provided; and
the generator selects data to be used as the raw data for the processing to be executed from among the plurality of data elements stored in the second memory in accordance with the environments of the processing request source indicated by the environment information.

14. An information processing method comprising:
generating, on the basis of instruction information which describes processing to be executed for obtaining output data from raw data, processing definition information that defines details of the processing, upon inputting the instruction information from a processing request source;
making a determination regarding whether output data associated with the generated processing definition information and associated with data to be used as raw data for the processing to be executed, which is defined by the processing definition information, is stored in a first memory, the first memory storing therein output data which has been obtained from raw data as a result of executing processing in accordance with previously generated processing definition information in association with data used as the raw data and the processing definition information; and
outputting, if it is determined that the output data associated with the generated processing definition information and the data to be used as the raw data for the processing to be executed is stored in the first memory, the output data stored in the first memory without executing the processing.

15. An information processing method comprising:
generating, on the basis of instruction information which describes processing to be executed for obtaining output data from raw data, processing definition information that defines details of the processing, upon inputting the instruction information from a processing request source;
making a determination regarding whether output data associated with the instruction information which describes processing to be executed and associated with data to be used as raw data for the processing to be executed is stored in a first memory, the first memory storing therein output data which has been obtained from raw data as a result of executing processing in accordance with previously generated processing definition information in association with data used as the raw data and previously input instruction information; and
outputting, if it is determined that the output data associated with the instruction information which describes processing to be executed and the data to be used as the raw data for the processing to be executed is stored in the first memory, the output data stored in the first memory without executing the processing.

16. A computer readable medium storing a program causing a computer to execute a process, the process comprising:
generating, on the basis of instruction information which describes processing to be executed for obtaining output data from raw data, processing definition information that defines details of the processing, upon inputting the instruction information from a processing request source;
making a determination regarding whether output data associated with the generated processing definition information and associated with data to be used as raw data for the processing to be executed, which is defined by the processing definition information, is stored in a first memory, the first memory storing therein output data which has been obtained from raw data as a result of executing processing in accordance with previously generated processing definition information in association with data used as the raw data and the processing definition information; and
outputting, if it is determined that the output data associated with the generated processing definition information and the data to be used as the raw data for the processing to be executed is stored in the first memory, the output data stored in the first memory without executing the processing.

17. A computer readable medium storing a program causing a computer to execute a process, the process comprising:
generating, on the basis of instruction information which describes processing to be executed for obtaining output data from raw data, processing definition information that defines details of the processing, upon inputting the instruction information from a processing request source;
making a determination regarding whether output data associated with the instruction information which describes processing to be executed and associated with data to be used as raw data for the processing to be executed is stored in a first memory, the first memory storing therein output data which has been obtained from raw data as a result of executing processing in accordance with previously generated processing definition information in association with data used as the raw data and previously input instruction information; and
outputting, if it is determined that the output data associated with the instruction information which describes processing to be executed and the data to be used as the raw data for the processing to be executed is stored in the first memory, the output data stored in the first memory without executing the processing.
